(19) United States
(12) Patent Application Publication
(10) Pub. No.: US 2008/0103045 A1
(43) Pub. Date: May 1, 2008

(54) Preparation For Eradicating Algae And Microorganisms In Aqueous Environment

(75) Inventors: Ales Hrdlicka, Brno (CZ); Jiri Drimal, Brno (CZ)

Correspondence Address: WOOD, HERRON & EVANS, LLP, 2700 CAREW TOWER, 441 VINE STREET, CINCINNATI, OH, 45202, US

(73) Assignee: LIFETECH S.R.O., Brno, CZ (CZ)

(21) Appl. No.: 11/814,262

(22) PCT Filed: Oct. 7, 2005
(86) PCT No.: PCT/CZ05/00075

§ 371 Date: Jul. 18, 2007

(30) Foreign Application Priority Data
Jan. 21, 2005 (CZ) PV 2005-42

(51) Int. Cl. A01N 59/16; A01N 59/20; A01P 13/00

(52) U.S. Cl. 504/121

(57) ABSTRACT

In the preparation for eradicating algae and microorganisms in aqueous environment containing cations of copper(II), silver(I) or zinc(II) in form of their salts, or generated electrolytically, or possibly released by diffusion from metallic materials, at least one of the following compounds shall be present as a stabilizing element, and at the same time as an element enhancing the efficiency of the preparation: amidosulfonic acid (CAS No. 5329-14-6), its salt, its ester, sulfamide (CAS No. 7803-58-9).

### TECHNICAL FIELD

The present invention relates to a preparation for controlling and eradicating algae and microorganisms in the aqueous environment. This preparation contains cations of transition metals, particularly cations of copper(II), silver(I) or zinc(II) in the form of their salts or generated electrolytically or released by diffusion from metallic materials.

### BACKGROUND OF THE INVENTION

The growth of algae is controlled by preparations intended primarily for algae eradication, i.e. by algaecides, or by compositions whose primary functions are disinfection and oxidation, such as ozone or compounds of chlorine or bromine. Extensively used are algaecides containing quaternary ammonium salts, such as dialkyl dimethyl ammonium salts or polymeric quaternary ammonium salts (polyquats). The doses of these preparations are relatively high and they have to be repeated regularly due to the decomposition of the active components. Test kits for monitoring these algaecides concentrations are scarcely available. The decomposition products of quaternary ammonium salts accumulate in the recirculated water, tending to support the growth of microorganisms. Further drawbacks of this group of algaecides are their lower efficiency in hard water, skin irritation of sensitive persons and, in some cases, the occurrence of turbidity as well.

Another important group of algaecides makes use of the algicidal properties of ions of some transition metals. This concerns especially the copper cations Cu(II) having algicidal and bacteriostatic effects. The algicidal effect is due to the replacement of the magnesium cation in the chlorophyll molecule by the Cu(II) cation. This change is irreversible. The chlorophyll is loosing its capacity to bind carbon dioxide that is indispensable for photosynthesis and, accordingly, the algae are killed. The advantage of this mechanism resides in that the algae cannot eliminate this effect. Zinc salts and even the salts of bivalent or tetravalent tin have been used, too. The application of copper(II) cations can be combined with the application of silver(I) cations having bactericidal effect. As compared with other transition metals, the applied concentrations of Cu(II) cations and, also, the toxicity of Cu(II) cation are lower.

Metal cations can be dosed into water in the form of their salts. In this case, the formation of compounds with low solubility proceeds gradually as well as bonding of the metal cations to organic matter. Concentration of Cu(II) cations, i.e. the effective form, decreases relatively quickly within a few days. This process proceeds faster in hard water with high total alkalinity and this is the reason for increasing salt doses in such cases.

Uniform dosage of the metal cations can be achieved by their electrolytic generation from metallic electrodes containing Cu(II) and Ag(I) (U.S. Pat. No. 6,562,243) or Cu(II) and Zn(II) (U.S. Pat. No. 6,207,060) or, e.g. from granulated copper and zinc in a so-called electrolytic filter (U.S. Pat. No. 5,279,748).

The main disadvantage of the mentioned methods of application is the instability of metal cations in the aqueous environment and a relatively fast drop of the concentration of their active form. To stabilize Cu(II) cations, organic compounds forming complexes or chelates with metal cations are added to algicidal preparations. These compounds comprise quaternary ammonium salts having algicidal effect themselves, such as diallyl dimethyl ammonium chloride (U.S. Pat. No. 6,420,312, U.S. Pat. No. 6,576,594, U.S. Pat. No. 6,248,369, U.S. Pat. No. 6,069,113), alkyl dimethyl benzyl ammonium chloride (U.S. Pat. No. 4,952,398), 2-ethylhexyl dimethyl ammonium salt and a mixture of dialkyl dimethyl ammonium salts prepared from fatty acids present in cocoa oil (U.S. Pat. No. 5,373,025).

Organic amines are broadly used for these purposes, too. Alkanolamines are applied, especially mixtures of monoethanolamine and triethanolamine (U.S. Pat. No. 2,734,028, U.S. Pat. No.4,324,578, U.S. Pat. No. 3,930,834). For better stability of these preparations ammonium cations can be added (U.S. Pat. No. 4,030,907). Another suitable group of organic amines are alkylenediamines, e.g. ethylenediamine (U.S. Pat. No. 4,361,435).

Also 1-hydroxyethane-1,1-diphosphonic acid, i.e. hydroxyethylidene diphosphonic acid, (U.S. Pat. No. 3,844,760) as well as ethylenediaminetetraacetic acid and its salts (U.S. Pat. No. 5,149,354, US Pat. App. 2003/0022793A1) are in use as complexing agents.

The disadvantages of organic complexing agents are their toxicity and their gradual decomposition accelerated by light and heat. Furthermore, the copper(II) cations are bound too strongly in complexes with some of these compounds—for example chelate with ethylenediaminetetraacetic acid has the value of conditioned stability constant log Kₛ=18,8, complex with molar ratio Cu(II)/ethylenediamine=1:2 has log Kₛ=20.03, and complex with triethanolamine has the value of log Kₛ=4.1. From the viewpoint of algicidal effects, the application of Cu(II) in form of such complex compounds is not expedient, the concentration of the active form, i.e. free Cu(II) cations, being too low in these cases.

It is therefore the aim of the present invention to find an appropriate inorganic stabilizer with low toxicity for preventing the precipitation of cations, however without too strong bonding of these cations, which could disturb their algicidal, bacteriostatic or bactericidal effect. The products of a possible decomposition of such stabilizer should not be toxic and they should burden the environment to the least possible extent.

### SUMMARY OF THE INVENTION

The above task is solved by a preparation for eradicating algae and microorganisms in aqueous environment containing cations of transition metals, especially cations of copper(II), zinc(II), or silver(I) in form of their salts, or generated electrolytically, or released by diffusion from metallic materials while at least one of the following compounds shall be present as a stabilizing element, and at the same time as an element enhancing the efficiency of the preparation: amidosulfonic acid (CAS No. 5329-14-6), its salt, its ester, sulfamide (CAS No. 7803-58-9).

The ratio of the total number of moles of the amidosulfonic acid and the above compounds derived from the same, at the one hand, and the total number of moles of cations of transition metals at the other hand, vary in the mixture within the optimum range from 1:50 to 100:1.

The preparation can be created by separate components to be prepared in situ by mixing the components, or the mixture can be in solid phase or in form of a solution.

### SPECIFIC EMBODIMENTS OF THE INVENTION

The preparation according to the invention can be applied in swimming pools, whirlpools, cooling towers and other water reservoirs with recirculated water, and also in natural or artificial basins serving, e.g. for fish breeding, supply of water or for recreation or decoration purposes. Another field of application are tanks containing biological waste with higher water contents, such as liquid manure pits, wherein the mixture inhibits the proliferation of bacteria, and, thus, the creation of undesirable products of their metabolism. The preparation can be applied into the drinking water for animals, e.g. in pig breeding where the concentration of ammonia in the breeding environment is considerably decreased due to the application. It can be also applied into the warm water distribution system for eradicating microorganisms, such as Legionella.

### EXAMPLE 1

A laboratory study of the sensitivity of some species of algae and blue green algae (Cyanobacteria) against copper cations in form of copper sulfate and in the form of preparation containing copper sulfate and amidosulfonic acid in molar ratio of 1:2 has shown that the preparation has a markedly higher biocidal effect. The acute toxicity characterized by values of effective EC50 concentrations of copper cations for the copper sulfate and the preparation according to the present invention has been compared in the following table.

EC50 (mg/l Cu(II))

| Algae/Cyanobacteria | copper sulfate | preparation |
|---|---|---|
| Raphidocelis subcapitata | 1.27 | 1.01 |
| Scenedesmus | 1.15 | 0.65 |
| quadricauda | | |
| Chlorella kessleri | 1.14 | 0.80 |
| Synechococcus | 1.26 | 0.57 |
| leopoliensis | | |
| Mycrocystis incerta | 1.26 | 0.48 |
| Anabaena sp. | 0.50 | 0.61 |

### EXAMPLE 2

High concentrations of ammonia in the air of barns and stables have adverse effect upon the health and utility of farm animals. The ammonia concentration from 25 to 35 ppm v/v irritates the mucosa of the eyes and of the respiratory tract. A concentration of 50 ppm v/v leads to serious impairment of the health and animal production efficiency, pneumonia occurrence is seen to rise.

For most organisms copper is an indispensable trace element and in farm animals the receipt of a certain amount in the feeding doses is necessary. Copper sulfate in amounts of 0.4-0.9 kg/t, accordingly, is an indispensable component part of fodder mixtures used in a certain phase of pig breeding.

A mixture containing copper sulfate and amidosulfonic acid in the molar ratio 1:2 was continuously applied, on the one hand into drinking water (consumption of about 7.1 m³/day) for pig breeding, on the other hand into some of the manure pits. The Cu(II) concentration in drinking water was 1 mg/l, in the liquid manure 2 mg/l. The concentration of ammonia in ambient air in the barns, as measured always under the same conditions at the height of 50 cm above the floor, dropped within two weeks from the original values of 60-80 ppm v/v at the start of application down to 20 ppm v/v and then maintained the latter value. After a ten-day disruption of dispensing the preparation into drinking water, the ammonia concentration in the air was observed to rise from 20 up to 40 ppm v/v. When the dosing was renewed, the ammonia concentration dropped again to 20 ppm v/v within ten days.

During the one-year application the production efficiency of the saw herd was improved: the number of births increased, the pregnancy of saws improved—the gestation percentage increased from 48.1%, as achieved in the previous year, to 66.3% in the year of application. At the same time the suckling pigs' deaths were seen to drop from 14.9% in the previous year to 11.0%. After weaning, the piglets did not suffer from diarrhoea that is current at this stage. No medication had to be used in the herd during the experiments and just single pieces got the minimum drugs. Yet another contribution was the improved working environment for the breeders, and intensive ventilation of the barns was not necessary during the winter period.

1-4. (canceled)

5. A method comprising preparation for eradication of algae and diminishing growth and/or elimination of some bacteria in aqueous media containing:
a) copper(II) and/or zinc(II) and/or silver(I) cations in the form of their water soluble salts, or said cations generated electrolytically, or said cations released by diffusion from their metallic materials, and simultaneously
b) at least one of amidosulfonic acid (CAS No. 5329-14-6), its salt, its ester, or sulfamide (CAS No. 7803-58-9).

6. The method of claim 1 wherein a ratio of the total number of moles of the amidosulfonic acid and the above compounds derived from the same, on the one hand, and the total number of moles of metal cations on the other hand, vary in the mixture within the range of 1:50 to 100:1.

7. The method of claim 6 wherein the preparation is prepared in situ by mixing the components.

8. The method of claim 6 wherein the mixture is in either solid phase or solution.
